(19) United States
(12) Patent Application Publication
(10) Pub. No.: US 2007/0292317 A1
(43) Pub. Date: Dec. 20, 2007

(54) Reagent reaction container

(75) Inventors: Yi-Lung Lee, Taichung County (TW); Chin-Sung Lin, Taichung County (TW); Shun-Wu Hong, Kaohsiung City (TW); Zhen-Hua Chou, Hualien County (TW)

Correspondence Address: BROWDY AND NEIMARK, P.L.L.C.;624 NINTH STREET, NW, SUITE 300, WASHINGTON, DC, 20001-5303, US

(73) Assignee: Antera Biotech Corp., Taichung City (TW)

(21) Appl. No.: 11/700,070

(22) Filed: Jan. 31, 2007

(30) Foreign Application Priority Data
Jun. 15, 2006 (TW) 95121495

(51) Int. Cl. B01J 19/00

(52) U.S. Cl. 422/130

(57) ABSTRACT

A reagent reaction container includes a container body having a plurality of receiving bores through top and bottom sides thereof, a plurality of filter holders mounted in the receiving bores respectively and each having a through hole through top and bottom sides thereof and an engagement portion engaged with a periphery wall of the respective receiving bore, a plurality of drain elements mounted in the through holes of the filter holders respectively, and a plurality of filters respectively mounted in the through holes of the filter holders and supported on the respective drain element. The drain element has a crevice that is closed when the drain element receives no pressure and is opened when the drain element receives a predetermined external force.

### BACKGROUND OF THE INVENTION

1. Field of the Invention

The present invention relates generally to biochemical experiment apparatus and more specifically, to a reagent reaction container for use in a biochemical experiment apparatus.

2. Description of the Related Art

A reagent reaction container is a container for conducting reactions with liquid reagents and samples to produce a compound (solid).

After the end of a reaction and the production of a compound, the residual liquid or cleaning solution must be separated from the compound and carried away from the container. Therefore, a drain membrane is provided at the bottom side of each receiving bore of the container. After the production of a compound, a compressed gas is applied to the receiving bore to expand the capillaries of the drain membrane for allowing the residual liquid to discharged out of the receiving bore. However, frequently apply a compressed gas to the drain membrane may damage the wick structure of the drain membrane. Further, because the diameter of the capillaries of the wick structure of the drain membrane is still very small when expanded, the drain speed is slow such that it takes much time when discharging the residual liquid out of the receiving bore of the container. Therefore, it is not an economic way to drain the residual liquid in this manner.

### SUMMARY OF THE INVENTION

The present invention has been accomplished under the circumstances in view. It is one objective of the present invention to provide a reagent reaction container, which can accelerate the drain speed of the residual liquid.

To achieve this objective of the present invention, the reagent reaction container comprises a container body having a receiving bore through top and bottom sides thereof, a filter holder mounted in the receiving bore and having a through hole through top and bottom sides thereof and an engagement portion engaged with a periphery wall of the receiving bore, a drain element mounted in the through hole of the filter holder, and a filter mounted in the through hole of the filter holder and supported on the drain element. The drain element has a crevice that is closed when the drain element receives no pressure and opened when the drain element receives a predetermined external force.

In a preferred embodiment of the present invention, the container body has a plurality of receiving bores. An equivalent number of filter holders each holding one drain element and one filter therein are respectively mounted in the receiving bores.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a reagent reaction container according to a preferred embodiment of the present invention;

FIG. 2 is a sectional view in an enlarged scale of a part of the reagent reaction container according to the preferred embodiment of the present invention;

FIG. 3 is a schematic drawing showing that the residual liquid passes through the crevice of the drain element;

FIG. 4 is a perspective view of the drain element of the present invention, showing that the crevice of the drain element is opened, and

FIG. 5 illustrates an alternate form of the drain element according to the present invention.

### DETAILED DESCRIPTION OF THE INVENTION

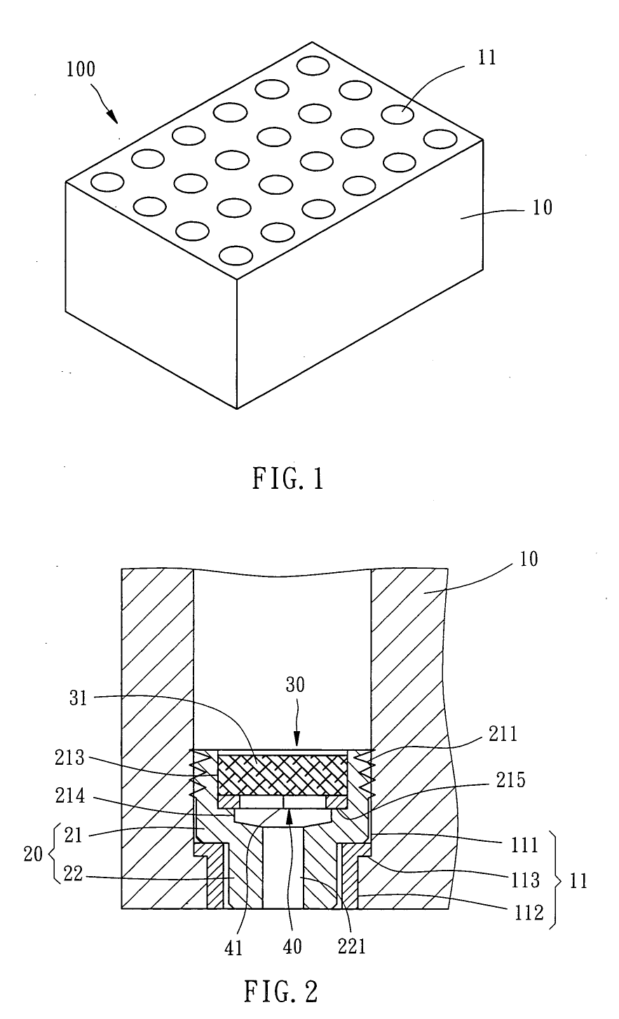

As shown in FIGS. 1 and 2, a reagent reaction container 100 in accordance with a preferred embodiment of the present invention comprises a container body 10, a plurality of filter holders 20, a plurality of filters 30, and a plurality of drain elements 40.

The container body 10 has a plurality of independent stepped receiving bores 11 through the top and bottom sides thereof. Each receiving bore 11 has a large-diameter section 111, a small-diameter section 112, and a step 113 defined between the large-diameter section 111 and the small-diameter section 112.

The filter holders 20 are respectively molded from plastics, polyurethane or rubber. Each of the filter holders has a head 21 of relatively greater outer diameter, a shank 22 of relatively smaller outer diameter integrally connected with the head 21, a step defined between the head 21 and the shank 22, a toothed engagement portion 211 defined around the periphery of the head 21, and a stepped through hole through the top and bottom sides thereof. The through hole of the filter holder 20 has a large-diameter section 213, a medium-diameter section 214, a step 215 defined between the large-diameter section 213 and the medium-diameter section 214, and a small-diameter section 221.

The filters 30 are wire gauze filters in the present embodiment, each having staggered arrays of openings 31 at different elevations.

The drain elements 40 are made of polytetrafluoroethylene (TEFLON), each having a crossed crevice 41 as shown in FIG. 4. FIG. 5 shows an alternate form of the drain element. According to this alternate form, the drain element 50 has an elongated crevice 51 other than the crossed crevice 41 as shown in FIG. 4. When the drain element 40 or 50 receives no pressure, the crevice 41 or 51 is closed. On the contrary, when the drain element 40 or 50 receives a pressure, the respective crevice 41 or 51 is opened.

After introduction of the structure of every part of the reagent reaction container 100, the assembly process of the reagent reaction container 100 and its operation are described hereinafter.

Referring to FIGS. 1 and 2 again, the drain elements 40 are respectively inserted into the large-diameter sections 213 in the filter holders 20 (the quantity of the drain elements is equal to the quantity of the filter holders) and supported on the respective steps 215 in the respective filter holders 20, and then the wire gauze filters 30 are respectively inserted into the large-diameter sections 213 in the filter holders 20 (the quantity of the wire gauze filters is equal to the quantity of the filter holders) and supported on the respective drain elements 40, and then the filter holders 20 with the associated drain elements 40 and wire gauze filters 30 are respectively inserted into the receiving bores 11 in the container body 10 (the quantity of the filter holders is equal to the quantity of the receiving bores of the container body) to force the toothed engagement portion 211 of the head 21 of each filter holder 20 into engagement with the peripheral wall of each of the receiving bores 11 and to have the step defined between the head 21 and the shank 22 of each filter holder 20 be respectively supported on the step 113 in each of the receiving bores 11, and therefore the filter holders 20 are respectively and firmly positioned in the receiving bores 11 of the container body 10.

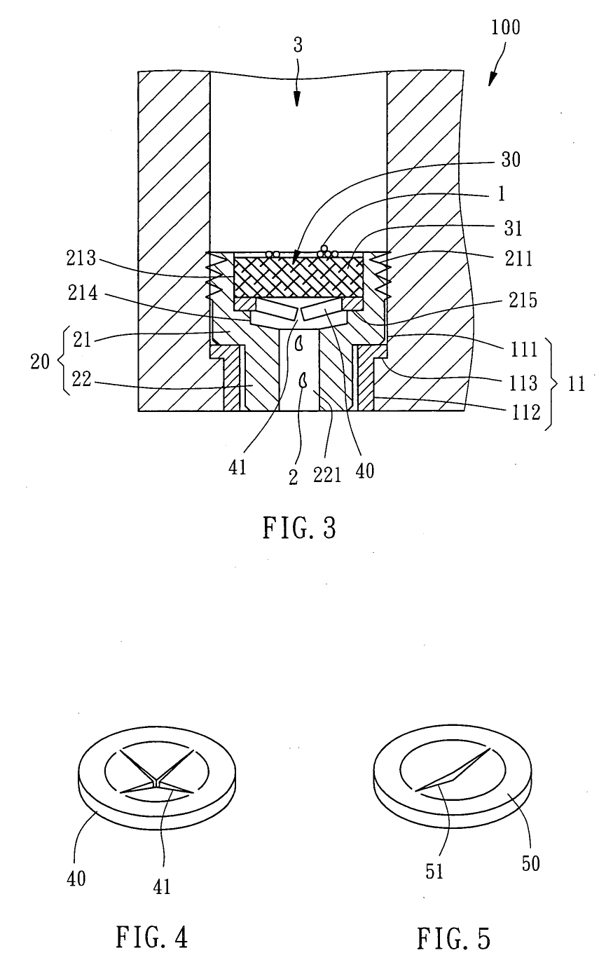

Referring to FIG. 3, when different liquids are dispensed into one receiving bore 11 to cause a reaction and to further produce a solid compound 1 on the wire gauze filter 30, a gas 3 (normally nitrogen gas) can be filled into the receiving bore 11 to force the crevice 41 of the drain element 40 to open (see FIG. 4), so that the residual liquid (or cleaning solution) 2 can flow away from the solid compound 1 through the openings 31 of the wire gauze filter 30 and the crevice 41 of the drain element 40 to the outside of the container body 10 of the reagent reaction container 100 via the small-diameter section 221 of the filter holder 20.

Further, the size of the crevice 41 of each drain element 40 is determined subject to a proper calculation so that the crevice 41 does not open when the drain element 40 receives no pressure, and will open immediately to guide away the residual liquid 2 upon a pressure (gas pressure). Further, because the drain element 40 is supported on the step 215 of the filter holder 20, the step 215 limits the degree of deformation of the drain element 40 when bearing the pressure of the applied gas 3. Further, the size of the openings 31 of the wire gauze filter 30 is well selected, so that the produced solid compound 1 is well kept on the wire gauze filter 30 and will not fall to the openings 31.

What is claimed is:

1. A reagent reaction container comprising:
a container body having at least one receiving bore through top and bottom sides thereof;
at least one filter holder mounted in the at least one receiving bore of the container body, the at least one filter holder having a through hole through top and bottom sides thereof and an engagement portion engaged with a periphery wall of the at least one receiving bore;
at least one drain element mounted in the through hole of the at least one filter holder, the drain element having a crevice that is closed when the drain element receives no pressure and opened when the drain element receives a predetermined external force; and
at least one filter mounted in the through hole of the at least one filter holder and supported on the at least one drain element, the at least one filter having a plurality of openings.

2. The reagent reaction container as claimed in claim 1, wherein the receiving bore has a large-diameter section, a small-diameter section and a step defined between the large-diameter section and the small-diameter section; the filter holder has a head, a shank integrally connected with the head, and a step defined between the head and the shank and stopped at the step of the receiving bore.

3. The reagent reaction container as claimed in claim 1, wherein the filter holder is molded from plastics.

4. The reagent reaction container as claimed in claim 1, wherein the filter holder is molded from rubber.

5. The reagent reaction container as claimed in claim 1, wherein the engagement portion is provided with teeth thereon.

6. The reagent reaction container as claimed in claim 1, wherein the through hole of the filter holder has a step on which the drain element is supported.

7. The reagent reaction container as claimed in claim 1, wherein the openings of the filter are arranged in staggered arrays at different elevations.

8. The reagent reaction container as claimed in claim 1, wherein the drain element is made of polytetrafluoroethylene.

9. The reagent reaction container as claimed in claim 1, wherein the crevice of the drain element is an elongated crevice.

10. The reagent reaction container as claimed in claim 1, wherein the crevice of the drain element is a crossed crevice.
